(19) United States
(12) Patent Application Publication
(10) Pub. No.: US 2002/0086085 A1
(43) Pub. Date: Jul. 4, 2002

(54) Robot for production machine

(76) Inventors: Kazutoshi Takayama, Nagano (JP); Atsuo Matsui, Nagano (JP)

Correspondence Address: BIRCH, STEWART, KOLASCH AND BIRCH, P.O.Box 747, Falls Church, VA, 22040-0747, US

(21) Appl. No.: 09/753,666

(22) Filed: Jan. 4, 2001

(51) Int. Cl. B29C 45/42

(52) U.S. Cl. 425/556; 425/444; 425/437; 425/DIG. 60

(57) ABSTRACT

A robot for a production machine including a rotation drive unit disposed on a support base; a first arm having a proximal end portion fixed to a rotary shaft of the rotation drive unit; a first proximal-side pulley disposed coaxially with the rotary shaft and fixed to the support base; a second proximal-side pulley fixed to a distal end portion of the first arm; an intermediate shaft rotatably supported on the distal end portion of the first arm and penetrating a center portion of the second proximal-side pulley; a first distal-side pulley provided integrally with the intermediate shaft; a first rotation transmission section for drivingly connecting the first distal-side pulley and the first proximal-side pulley; a second arm having a proximal end portion fixed to the intermediate shaft; a distal-side shaft rotatably supported on a distal end portion of the second arm; a second distal-side pulley provided integrally with the distal-side shaft; a second rotation transmission section for drivingly connecting the second distal-side pulley and the second proximal-side pulley; and a chuck fixed to the distal-side shaft. The tooth-number ratio between the first proximal-side pulley and the first distal-side pulley is set to n:l. The tooth-number ratio between the second proximal-side pulley and the second distal-side pulley is set to 1:m.

### BACKGROUND OF THE INVENTION

1. Field of the Invention

The present invention relates to a robot for a production machine which is used as a product removal apparatus for removing products from a production machine such as an injection molding machine, or as an insert-part-loading apparatus for loading an insert part into a mold or the like.

2. Description of the Relevant Art

There has been known a product removal apparatus (robot for a production machine) which is added to an injection molding machine and which removes a product (molded product) ejected from an opened mold by an ejector and transports the product to a product stocker disposed adjacent to the injection molding machine.

A conventionally-used product removal apparatus is a traverse-type product removal apparatus which is designed to move linearly a chuck capable of holding and releasing a product along X, Y, and Z directions. However, such a traverse-type product removal apparatus involves a drawback in that since the apparatus must have a size corresponding to the stroke of movement of the chuck along each direction, the apparatus is comparatively large overall, and an installation space corresponding to the stroke of movement is required.

In order to solve the above-described drawback, Japanese Utility Model Publication Nos. 4 (1992)-45861, 5 (1993)-40989, and others propose an improved product removal apparatus in which an articulated robot having a plurality of linked arm portions is used in order to reduce movement area to thereby reduce the size and installation space.

Meanwhile, a mold clamp apparatus of an injection molding machine includes four tie bars, which slidably support a movable platen to which is attached a movable die. Therefore, a molded product must be removed through a space between the tie bars without causing interference with the tie bars. Accordingly, the chuck of a product removal apparatus must be moved linearly at lest along the vertical direction, and the chuck must be maintained in a constant posture (orientation). In the case of the above-described articulated robot, since fundamental motions are produced by means of rotation of respective joint portions, when the chuck is to be moved linearly, two arm portions must be moved in a combined manner through simultaneous control of rotational angles of the two arm portions.

However, when a chuck is secured to a distal end of an articulated arm, the orientation of the chuck changes depending on the rotational angles of the arm portions. Therefore, the conventional product removal apparatus of the articulated robot type which has been provided in injection molding machines requires an additional drive mechanism for correcting the orientation of the chuck. This results in an increase in the number of parts, an increase in difficulty in designing a control system, and an increase in cost stemming from an increased degree of complexity of hardware and software. Further, the overall size and weight of the part removal apparatus increase.

### SUMMARY OF THE INVENTION

An object of the present invention is to provide a robot for a production machine which is advantageously disposed in an injection molding machine and which can stably and smoothly remove a molded product through a space between tie bars without causing interference with the tie bars, even when the molded product is large.

Another object of the present invention is to provide a robot for a production machine which can reduce the number of components including servomotors and simplify the control system in order to greatly simplify hardware and software to thereby reduce the overall cost of the apparatus, as well as the size and weight of the apparatus.

In order to achieve the above-described object, the present invention provides a robot for a production machine (a product removal apparatus or an insert-part-loading apparatus) which comprises: a rotation drive unit disposed on a support base; a first arm, a proximal end portion of the first arm being fixed to a rotary shaft of the rotation drive unit; a first proximal-side pulley disposed coaxially with the rotary shaft and fixed to the support base; a second proximal-side pulley fixed to a distal end portion of the first arm; an intermediate shaft rotatably supported on the distal end portion of the first arm, the intermediate shaft penetrating a center portion of the second proximal-side pulley; a first distal-side pulley provided integrally with the intermediate shaft; a first rotation transmission section for drivingly connecting the first distal-side pulley and the first proximal-side pulley; a second arm, a proximal end portion of the second arm being fixed to the intermediate shaft; a distal-side shaft rotatably supported on a distal end portion of the second arm; a second distal-side pulley provided integrally with the distal-side shaft; a second rotation transmission section for drivingly connecting the second distal-side pulley and the second proximal-side pulley; and a chuck fixed to the distal-side shaft, wherein the tooth-number ratio between the first proximal-side pulley and the first distal-side pulley is set to n:1; and the tooth-number ratio between the second proximal-side pulley and the second distal-side pulley is set to 1:m.

Thus, an articulated robot arm having first and second arms is constructed. In the robot for a production machine of the present invention, since the tooth-number ratio between the first proximal-side pulley and the first distal-side pulley is set to n:1 and the tooth-number ratio between the second proximal-side pulley and the second distal-side pulley is set to 1:m, when the first arm rotates upon operation of the rotation drive unit, the second arm rotates over an angle n times that over which the first arm rotates, and the chuck rotates over an angle 1/m times that over which the second arm rotates. Therefore, when n=m=2, the fixed angular position of the first proximal-side pulley is transmitted to the chuck without any change, so that the chuck assumes a constant orientation regardless of the rotational angle of the first arm. Further, the rotational angle of the second arm becomes double that of the first arm. Therefore, when the distance L2 between the center of the second proximal-side pulley and the center of the second distal-side pulley is set to be equal to the distance L1 between the center of the first proximal-side pulley and the center of the first distal-side pulley, the chuck moves along a straight line passing through the first proximal-side pulley.

### BRIEF DESCRIPTION OF THE DRAWINGS

FIG. 1 is a partially sectioned plan view of a product removal apparatus (robot for a production machine) according to an embodiment of the present invention;

FIG. 2 is a partially sectioned front view of the product removal apparatus;

FIG. 3 is a side view of an injection molding machine to which the product removal apparatus is attached;

FIG. 4 is a partially sectioned front view of the product removal apparatus which is attached to an injection molding machine in a different manner; and

FIG. 5 is a side view of the injection molding machine of FIG. 4.

### DETAILED DESCRIPTION OF THE PREFERRED EMBODIMENT

An embodiment of the present invention will next be described in detail with reference to the drawings. The accompanying drawings are illustrative of the embodiments and are not meant to limit the scope of the invention. In order to describe the invention clearly, detailed description of known parts is omitted.

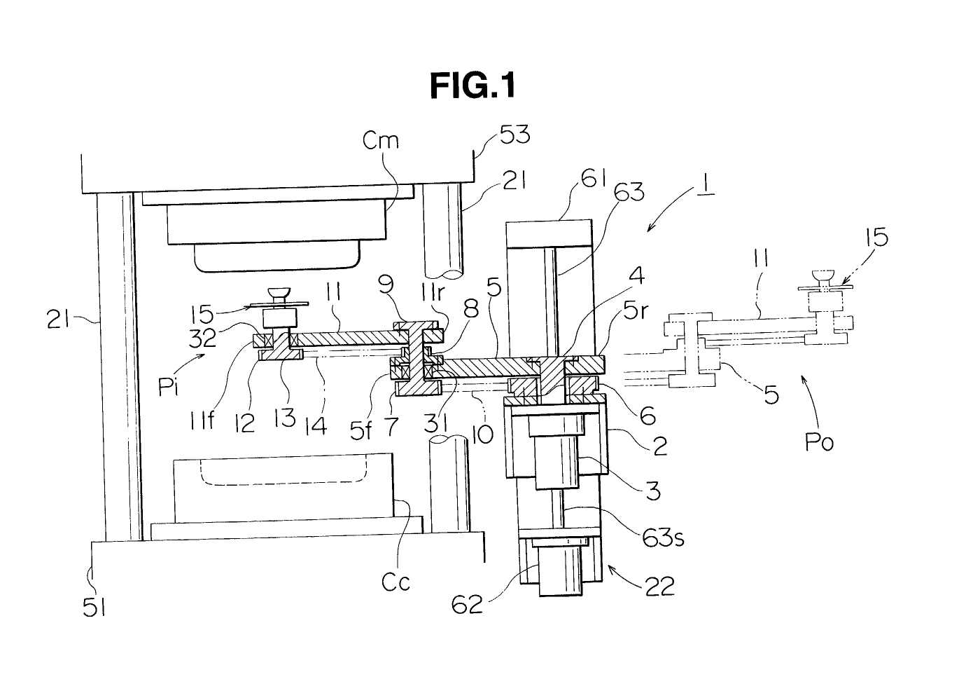

First, the structure of a main portion of a product removal apparatus (robot for a production machine) 1 according to the embodiment will be described with reference to FIGS. 1 to 3.

The product removal apparatus 1 comprises a support base 2, on which is disposed a rotation drive unit 3 utilizing a servomotor. A proximal end portion 5r of a first arm 5 is fixed to a tip end of a rotary shaft 4 of the rotation drive unit 3. A toothed first proximal-side pulley 6 is disposed coaxially on an intermediate portion of the rotary shaft 4 and is fixed to the support base 2. The first proximal-side pulley 6 assumes an annular shape and has a center through-hole, through which the rotary shaft 4 penetrates. An intermediate shaft 9 is rotatably attached to a distal end portion 5f of the first arm 5 via a bearing 31. A toothed first distal-side pulley 7 is integrally provided at one end of the intermediate shaft 9, and an endless timing belt constituting a first rotation transmission section 10 is extended between and wound around the first distal-side pulley 7 and the first proximal-side pulley 6.

A proximal end portion 11r of a second arm 11 is fixed to the other end of the intermediate shaft 9. A toothed second proximal-side pulley 8 fixed to the distal end portion 5f of the first arm 5 is disposed on an intermediate portion of the intermediate shaft 9; i.e., between the proximal end portion 11r of the second arm 11 and the distal end portion 5f of the first arm 5. The intermediate shaft 9 penetrates the center of the second proximal-side pulley 8 and is rotatable relative to the second proximal-side pulley 8. A distal-side shaft 13 is rotatably attached to a distal end portion 11f of the second arm 11 via a bearing 32. A toothed second distal-side pulley 12 is integrally provided at one end of the distal-side shaft 13, and an endless timing belt constituting a second rotation transmission section 14 is extended between and wound around the second distal-side pulley 12 and the second proximal-side pulley 8. A chuck 15 is supported on the other end of the shaft 13. The chuck 15 has a function of holding and releasing a product (molded product) and generally employs a vacuum suction mechanism or a mechanical gripping mechanism.

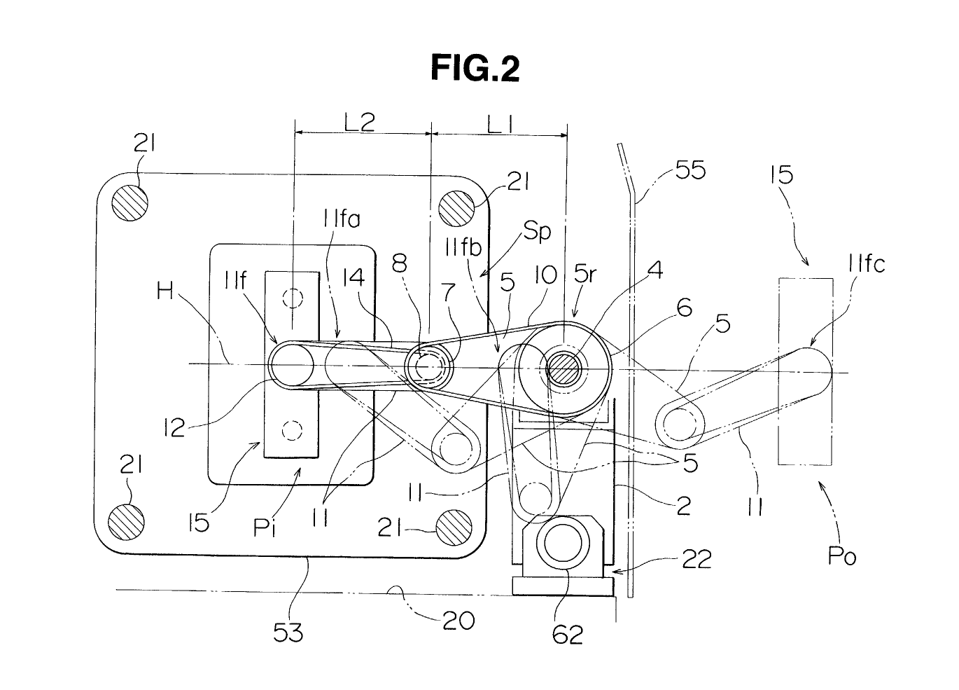

In the above-described structure, the tooth-number ratio between the first proximal-side pulley 6 and the first distal-side pulley 7 is set to 2:1; and the tooth-number ratio between the second proximal-side pulley 8 and the second distal-side pulley 12 is set to 1:2. Further, as shown in FIG. 2, the distance L2 between the center of the second proximal-side pulley 8 and the center of the second distal-side pulley 12 is set to be equal to the distance L1 between the center of the first proximal-side pulley 6 and the center of the first distal-side pulley 7.

Thus is constituted the main portion of the product removal apparatus 1 according to the present embodiment. The product removal apparatus 1 is attached to an injection molding machine in the following manner.

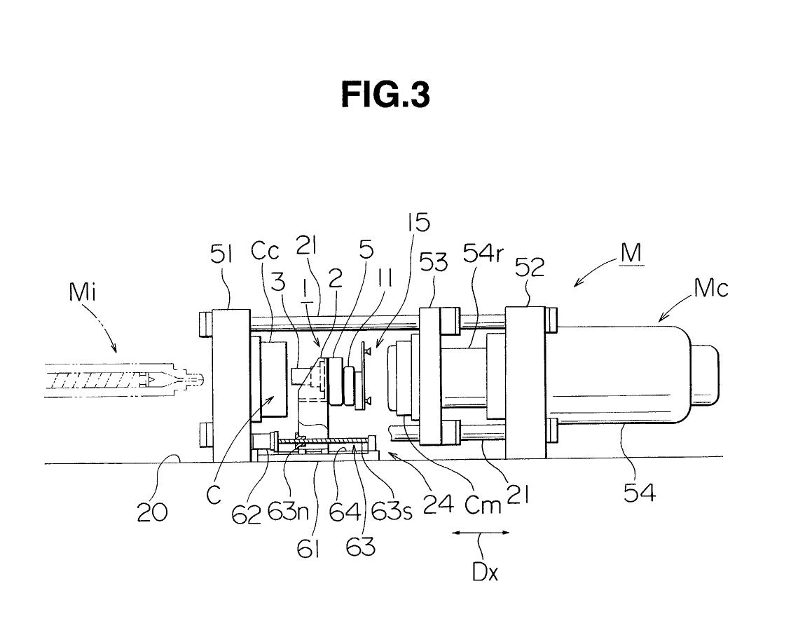

FIG. 3 shows an injection molding machine (in-line-screw-type injection molding machine) M including a mold clamp apparatus Mc and an injection apparatus Mi, both disposed on a bed 20 of the injection molding machine. The mold clamp apparatus Mc includes a stationary platen 51 fixedly disposed on the bed 20, and a drive-unit support platen 52 fixedly disposed on the bed 20 at a position separated from the stationary platen 51. Four tie bars (upper-left, upper-right, lower-left, and lower-right tie bars) 21 are disposed between the stationary platen 51 and the drive-unit support platen 52, and a movable platen 53 is slidably supported by the tie bars 21. Further, a movable-platen drive unit 54 is attached to the drive-unit support platen 52, and the distal end of a drive rod 54r of the movable-platen drive unit 54 is connected to the movable platen 53. A movable mold Cm is attached to the movable platen 53, and a stationary mold Cc is attached to the stationary platen 51. The movable mold Cm and the stationary mold Cc constitute a mold C. Notably, reference numeral 55 denotes a safety door.

A movement mechanism 22 is also disposed on the bed 20 of the injection molding machine. The movement mechanism 22 includes a base 61 fixed to the upper surface of the bed 20. A rotation drive unit 62 and a ball-screw mechanism 63 are disposed on the upper surface of the base 61. The rotation drive unit 62 includes an unillustrated servomotor. A screw shaft 63s of the ball-screw mechanism 63 is coupled to a rotary shaft of rotation drive unit 62, and a nut 63n of the ball-screw mechanism 63 is coupled to the above-described support base 2. The bottom portion of the support base 2 is slidably supported by guide rails 64 provided on the base 61. Therefore, when the rotation drive unit 62 is operated, the screw shaft 63s rotates in order to move the support base 2 coupled to the nut 63n in the front/back direction Dx of the injection molding machine M.

As shown in FIG. 2, the rotation drive unit 3 is disposed at an intermediate vertical position between the upper and lower tie bars 21, such that when the first arm 5 and the second arm 11 are caused to extend straight as indicated by a solid line, the first arm 5 and the second arm 11 become parallel to a horizontal direction H. Thus, the chuck 15 can be moved along the horizontal direction H through a space Sp between the upper and lower tie bars 21.

Next, operation of the product removal apparatus 1 according to the present embodiment will be described with reference to FIGS. 1 to 3.

In FIG. 2, the product removal apparatus 1 shown by a solid line is located at an approach position Pi, and the first arm 5 and the second arm 11 extend along the horizontal direction H into the mold C. In this state, the movement mechanism 22 is operated and controlled in order to move the chuck 15 in the front/back direction Dx, whereby the chuck 15 becomes able to hold the molded product.

When the rotation drive unit 3 is operated, the first arm 5 rotates. As described above, the tooth-number ratio between the first proximal-side pulley 6 and the first distal-side pulley 7 is set to 2:1, and the tooth-number ratio between the second proximal-side pulley 8 and the second distal-side pulley 12 is set to 1:2. Therefore, when the first arm 5 rotates upon operation of the rotation drive unit 3, the second arm 11 rotates over an angle 2 times that over which first arm 5 rotates, and the chuck 15 rotates over an angle one-half that over which the second arm 11 rotates. Therefore, the fixed angular position of the first proximal-side pulley 6 is transmitted to the chuck 15 without any change, with the result that the chuck 15 assumes a constant orientation regardless of the rotational angle of the first arm 5.

Further, the rotational angle of the second arm 11 becomes double that of the first arm 5, and the distance L2 between the center of the second proximal-side pulley 8 and the center of the second distal-side pulley 12 is set to be equal to the distance L1 between the center of the first proximal-side pulley 6 and the center of the first distal-side pulley 7. Therefore, the chuck 15 moves along a straight line passing through the first proximal-side pulley 6. Specifically, when the first arm 5 is rotated by 180° from the approach position Pi, the distal end portion 11f of the second arm 11 moves successively to positions 11fa, 11fb, and 11fc indicated by imaginary lines, so that the distal end portion 11f reaches a retreat position Po outside the mold. During this movement, the center of the distal end portion 11f (the center of the second distal-side pulley 12) moves along the horizontal direction H indicated by an alternate long and short dash line, which enables the chuck 15 to be moved through the space Sp between the upper and lower tie bars 21. When the chuck 15 is moved to a position above an unillustrated product stocker, the chuck 15 is caused to release the product. As a result, the product is received in the product stocker.

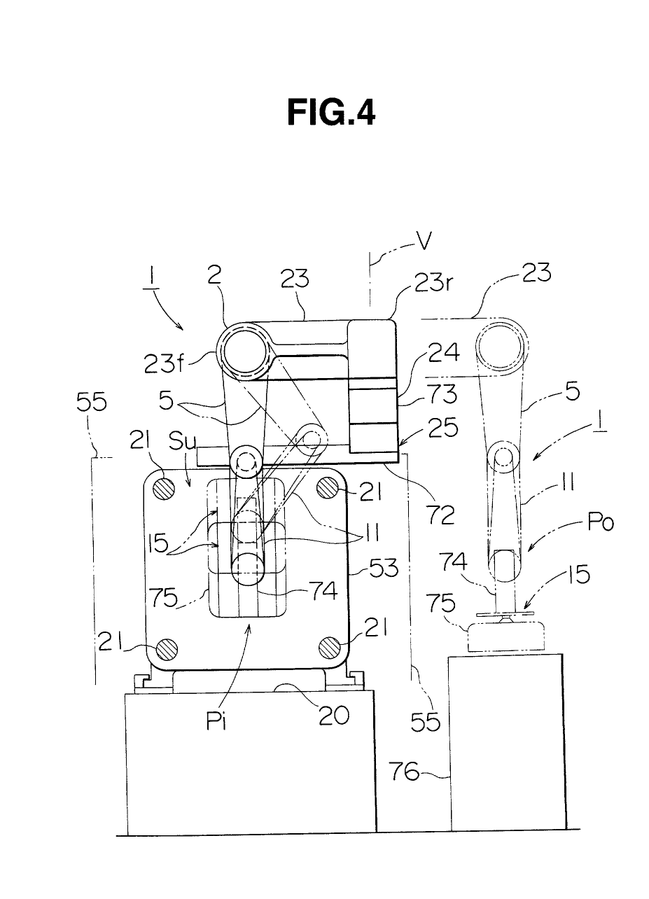

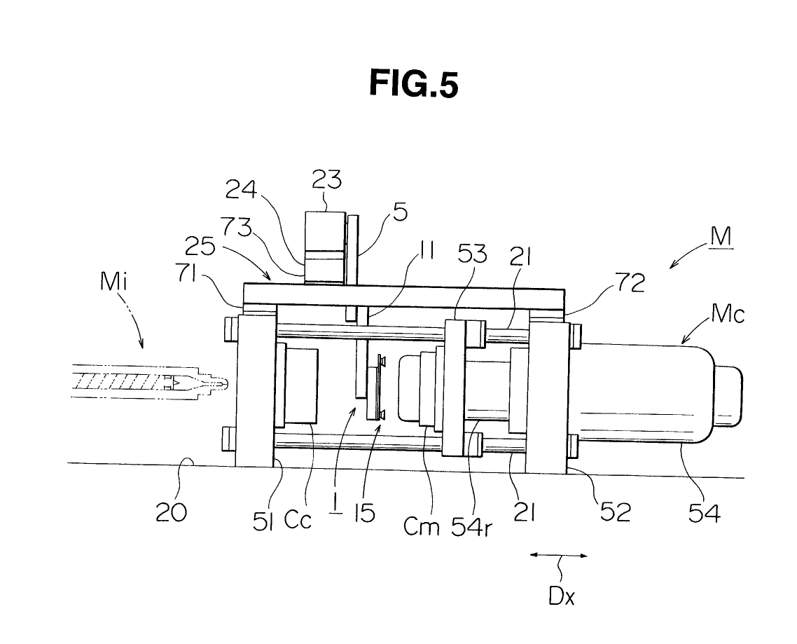

The product removal apparatus 1 may be attached to the injection molding machine M in a manner shown in FIGS. 4 and 5.

Support blocks 71 and 72 are fixed to the upper ends of the stationary platen 51 and the drive-unit support platen 52, which upper ends define the upper end of the injection molding machine M, and a movement mechanism 25 is disposed on the support blocks 71 and 72 in a straddling manner. The movement mechanism 25 includes a movable support 73, which is movable in the front/back direction Dx and which supports a rotation mechanism 24 thereon. The rotation mechanism 24 includes a horizontal arm 23 whose one end 23r is supported to be rotatable about an axis extending in the vertical direction V. The above-described support base 2 is provided at the other end 23f of the horizontal arm 23. The length of the horizontal arm 23 and others are determined such that, in the approach position Pi indicated by a solid line in FIG. 4, the other end 23f of the horizontal arm 23 is located at an intermediate position between the left and right tie bars 21. In the approach position Pi, the rotary shaft 4 of the rotation drive unit 3 becomes parallel to the front/back direction Dx of the injection molding machine M.

Notably, in FIG. 4, reference numeral 74 denotes an orientation changing mechanism for changing the orientation of the chuck 15 by 90° relative to the second arm 11; 75 denotes a molded product (product); and 76 denotes a product stocker. Among the portions shown in FIG. 4, the same portions as those shown in FIG. 2 are denoted by the same reference numerals; among the portions shown in FIG. 5, the same portions as those shown in FIG. 3 are denoted by the same reference numerals; and their repeated descriptions are omitted.

The product removal apparatus 1 shown in FIGS. 4 and 5 operates as follows. In FIG. 4, the product removal apparatus 1 shown by a solid line is located at the approach position Pi. In the approach position Pi, the chuck 15 faces the molded product 75, and the first arm 5 and the second arm 11 extend along the vertical direction V. In this state, the movement mechanism 25 is operated and controlled in order to move the chuck 15 in the front/back direction Dx, whereby the chuck 15 becomes able to hold the molded product 75. After the chuck 15 has held the molded product 75, the rotation drive unit 3 is operated so as to rotate the first arm 5. As a result, the chuck 15 moves upward along the vertical direction V while passing through the space Su between the left and right tie bars 21. When the chuck 15 has reached the elevated position, the rotation mechanism 23 is operated in order to rotate the horizontal arm 23 by 180° to thereby move the product removal apparatus 1 to a retreated position Po indicted by an imaginary line. Subsequently, the rotation drive unit 3 is operated so as to rotate the first arm 5, such that the chuck 15 moves downward along the vertical direction V. When the chuck 15 has reached the lower position, the orientation changing mechanism 74 is operated such that the chuck 15 faces downward. Subsequently, the chuck 15 is caused to release the molded product 75. As a result, the product 75 is received in the product stocker 76.

In the product removal apparatus 1 according to the present embodiment, the chuck 15 can be moved along a straight path, and the orientation (posture) of the chuck 15 can be maintained constant. Therefore, even a large molded product can be stably and smoothly removed through the space (space Sp, Su) between the tie bars 21 without causing interference with the tie bars 21. Further, since the basic motion can be realized by the single rotation drive unit 3, the number of components, including servometers, can be reduced, and the control system can be simplified. Thus, hardware and software can be simplified greatly, so that the overall cost, size, and weight of the apparatus can be reduced.

While the present invention has been described with reference to the preferred embodiments, the present invention is not limited thereto. Regarding structural details, shapes, employed components, among others, modifications and any omission or addition may be possible as needed without departing from the scope of the invention. For example, in the above-described embodiment, an endless timing belt is used as a rotation transmission section for operatively connecting two pulleys. However, alternatively, an ordinary endless flat belt may be used. In this case, ordinary pulleys having no tooth may be used. Therefore, in the present invention, the term “tooth number” used in relation to pulleys encompasses a circumferential length of each pulley. Further, a gear mechanism including a plurality of meshed gears may be used as a rotation transmission section for operatively connecting two pulleys. In the embodiment, a description has been given for the case in which the tooth-number ratio between the first proximal-side pulley 6 and the first distal-side pulley 7 is set to 2:1; the tooth-number ratio between the second proximal-side pulley 8 and the second distal-side pulley 12 is set to 1:2; and the distance L2 between the center of the second proximal-side pulley 8 and the center of the second distal-side pulley 12 is set to be equal to the distance L1 between the center of the first proximal-side pulley 6 and the center of the first distal-side pulley 7. However, the travel locus of the chuck 15 may be changed freely through a slight change in the tooth-number ratio, the distance L1, and/or the distance L2. Therefore, in general, the tooth-number ratio between the first proximal-side pulley 6 and the first distal-side pulley 7 is set to n:1; and the tooth-number ratio between the second proximal-side pulley 8 and the second distal-side pulley 12 is set to 1:m. Further, the distance L2 is not necessary required to be set equal to the distance L1.

In the present embodiment, the production removal apparatus 1 for removing a product (molded product) from the opened mold C of the injection mold machine M has been described as an example robot for a production machine. However, the production removal apparatus 1 may be used as an insert-part-loading apparatus for loading an insert part into an opened mold. In this case, a parts stocker is disposed in place of the product stocker 76. The robot for a production machine (insert-part-loading apparatus) according to the present invention removes each of insert parts from the parts stocker and loads the same into the mold. Moreover, the application of the robot for a production machine according to the present invention is not limited to injection molding machines, and the robot for a production machine according to the present invention can be utilized in other types of production machines which are subjected to restrictions similar to those of injection molding machines.

What is claimed is:

1. A robot for a production machine, comprising:
a rotation drive unit disposed on a support base;
a first arm, a proximal end portion of the first arm being fixed to a rotary shaft of the rotation drive unit;
a first proximal-side pulley disposed coaxially with the rotary shaft and fixed to the support base;
a second proximal-side pulley fixed to a distal end portion of the first arm;
an intermediate shaft rotatably supported on the distal end portion of the first arm, the intermediate shaft penetrating a center portion of the second proximal-side pulley;
a first distal-side pulley provided integrally with the intermediate shaft;
a first rotation transmission section for drivingly connecting the first distal-side pulley and the first proximal-side pulley;
a second arm, a proximal end portion of the second arm being fixed to the intermediate shaft;
a distal-side shaft rotatably supported on a distal end portion of the second arm;
a second distal-side pulley provided integrally with the distal-side shaft;
a second rotation transmission section for drivingly connecting the second distal-side pulley and the second proximal-side pulley; and
a chuck fixed to the distal-side shaft, wherein
the tooth-number ratio between the first proximal-side pulley and the first distal-side pulley is set to n:1; and the tooth-number ratio between the second proximal-side pulley and the second distal-side pulley is set to 1:m.

2. A robot for a production machine according to claim 1, wherein the tooth-number ratio between the first proximal-side pulley and the first distal-side pulley is set to 2:1.

3. A robot for a production machine according to claim 1, wherein the tooth-number ratio between the second proximal-side pulley and the second distal-side pulley is set to 1:2.

4. A robot for a production machine according to claim 1, wherein the distance between the center of the second proximal-side pulley and the center of the second distal-side pulley is set to be equal to the distance between the center of the first proximal-side pulley and the center of the first distal-side pulley.

5. A robot for a production machine according to claim 1, wherein the support base is disposed on a bed of an injection molding machine; and the chuck is moved through a space between the upper and lower tie bars.

6. A robot for a production machine according to claim 5, wherein the support base is supported by a movement mechanism for effecting movement in the front/back direction of the injection molding machine.

7. A robot for a production machine according to claim 1, wherein a rotation mechanism is disposed at the upper end of an injection molding machine, the rotation mechanism including a horizontal arm whose one end is supported to be rotatable about an axis extending in the vertical direction; the support base is attached to the other end of the horizontal arm; and the chuck is moved through a space between tie bars disposed at two different positions in the transverse direction of the injection molding machine.

8. A robot for a production machine according to claim 7, wherein the rotation mechanism is supported by a movement mechanism for effecting movement in the front/back direction of the injection molding machine.
